(19) United States
(12) Patent Application Publication
(10) Pub. No.: US 2026/0226877 A1
(43) Pub. Date: Aug. 6, 2026

(54) EFFICIENT HEATING MANAGEMENT SYSTEM INTEGRATED TO A DIESEL ENGINE GENERATOR USING HEAT OBTAINED FROM AN EXTERNAL HEAT SOURCE TO ECONOMICALLY HEAT THE ENGINE BLOCK COOLANT

(71) Applicant: PANOTEKNIK JENERATOR ELEKTRIK SANAYI VE TICARET LIMITED SIRKETI, Konya (TR)

(72) Inventor: Ismail TASKIRAN, Konya (TR)

(73) Assignee: PANOTEKNIK JENERATOR ELEKTRIK SANAYI VE TICARET LIMITED SIRKETI, Konya (TR)

(21) Appl. No.: 19/150,922

(22) PCT Filed: Apr. 26, 2023
(86) PCT No.: PCT/TR2023/050393

§ 371 Date: Jul. 25, 2025

(51) Int. Cl. F01P 3/20; F01P 3/18; F01P 5/10; F01P 7/14; F01P 11/16; F02B 63/04

(52) U.S. Cl. CPC F01P 3/20; F01P 3/18; F01P 5/10; F01P 7/14; F01P 11/16; F02B 63/042

(57) ABSTRACT

The provided is generator systems that heat the engine blocks of diesel engine generators by utilizing an external heat source without the need for the built-in resistors, thereby reducing power consumption and emissions, and achieving efficiency-based heating without requiring external equipment. The generator system includes an external heat source, a circulation pump that circulates water taken from the external heat source, a temperature sensor that measures the temperature of the water from the heat source, water transfer pipes, a two-part exchanger that allows for heat transfer but prevents the mixing of water, a pressure gauge, a flow meter, a processor, a temperature sensor on the generator, a generator circulation pump, and a three-way valve.

### CROSS REFERENCE TO THE RELATED APPLICATIONS

This application is the national phase entry of International Application No. PCT/TR2023/050393, filed on Apr. 26, 2023, the entire contents of which are incorporated herein by reference.

### TECHNICAL FIELD

The invention pertains to generator systems that heat the engine blocks of diesel engine generators by utilizing an external heat source without the need for the built-in resistors, thereby reducing power consumption and emissions, and achieving efficiency-based heating without requiring external equipment. The generator system comprises an external heat source, a circulation pump that circulates water taken from the external heat source, a temperature sensor that measures the temperature of the water from the heat source, water transfer pipes, a two-part exchanger that allows for heat transfer but prevents the mixing of water, a pressure gauge, a flow meter, a processor, a temperature sensor on the generator, a generator circulation pump, and a three-way valve.

### BACKGROUND

In emergency situations such as power outages, emergency power generators, also known as mobile diesel generator systems, are ready to automatically come into operation. Generator manufacturers state in their maintenance and user guides that the ideal first start for these systems requires the engine block coolant temperature to be at least 40° C. (degrees Celsius). Starting the generator below this temperature makes the initial engine start difficult. When the engine fails to start during the first attempt, second or third attempts may occur, resulting in delayed power generation for critical loads that require energy. Additionally, starting the generator below the recommended temperature increases engine wear, reduces the starting load capacity, and increases fuel consumption and exhaust gas emissions. In automatic start-up generator sets, the recommended number of automatic start attempts, including ten seconds of waiting time between each start, is three in total. Diesel engines that fail to start after the third attempt cause the generator sets to go into alarm and shut down, resulting in power loss for the facility. Therefore, it is necessary to heat the engine block coolant circuit to run the generator motors without damage and at the highest possible starting efficiency. In the current technology, this heating process is carried out using systems that contain a resistance-based pot (block water heater). In this system, the cooling fluid circulating inside the generator motor block passes through one or more units with different electrical powers and numbers of resistors (1000 watts/3000 watts, etc.) that are selected depending on factors such as the motor cooling fluid capacity, motor model, location, generator model, and type. The water is heated to the desired temperature through these units (pot/block water heater). The heated water keeps the generator motor block jacket water circuit at the desired temperature. The liquid that is heated in the pot can circulate naturally, or it can be circulated more homogeneously and quickly within the cooling system using an external circulation pump. Therefore, external electrical energy is required to heat the generator motor block and circulate the liquid. These resistors, which are powered by grid electricity, consume a high amount of electricity and increase the carbon emissions accordingly. In environments without grid electricity (such as concerts, events, festivals, tests, production, temporary housing, etc. facilities made in remote areas, open land, or mountainous regions), it is not possible to heat generators without external electricity, leading to the aforementioned problems and losses. Our invention addresses this issue by providing a solution that does not require or consumes less external electrical energy.

### SUMMARY

An efficient heating management system integrated into a diesel engine generator that enables the heating of the engine block water using heat obtained from an external heat source characterized by comprising a circulation pump, a heat sensor that measures the temperature of the water coming from the heat source, water transfer pipes, a two-part heat exchanger in which the waters do not mix but heat transfer can be performed, a pressure gauge, a flow sensor, a heating efficiency system control unit further or an internal control device of the generator comprising a screen with an interface and a processor configured specifically for the invention, a heat sensor on generator, a generator circulation pump, a three-way motorized and/or non-motorized valve and a reporting module.

### DETAILED DESCRIPTION OF THE EMBODIMENTS

The invention relates to a system that can be integrated into any existing model generator and can be controlled by a generator control device. The system can be added to the generator later or can be produced integrated with the generator during production. The purpose of the invention is to eliminate the need for an extra heat source to heat the motor block water circuit, which needs to be at the ideal temperature when the generator is first started. This is achieved by circulating the hot water taken from an existing external heat source (which can be any one of the following without any restriction: hot water from an existing or more cost-effective boiler circuit, hot water heated by solar collectors, thermal spring water around the facility, or hot water obtained by natural gas consumption) inside the generator motor with the circulating water and transferring the heat, thus preventing the consumption of an extra source for heating cold water. The system comprises an external heat and an electricity source (for example, electricity is generated by a solar panel at the generator location to meet the electrical needs of the block water heater system such as battery charging circuit, heating resistance, heating circulation pump, optional oil/fuel/battery/alternator/motor oil pan heaters, generator internal lighting, etc.) a circulation pump, a temperature sensor measuring the temperature of the incoming water, water transfer pipes, a two-part heat exchanger that allows heat transfer without mixing the waters inside, pressure gauge, a heater efficiency system control unit further comprising a specially configured processor for the invention, or the generator's internal control device, a generator-mounted temperature meter, a generator circulation pump, and a three-way motorized or non-motorized valve. The generator integrated with the invention can already contain a pot tank with an exchanger.

The aim of the invention is to provide heating for the motor water of a generator by utilizing the existing heat energy at a low cost through an integrated system, which includes the generator motor block water circuit and the hot water taken from an external heat source, and enables the transfer of heat between the cold water in the generator and the hot water taken from the external heat source through the exchange circuit using the inlet/outlet circuits of the hot water, thereby heating the motor water.

As described above, the system that heats the water circulating inside the generator with hot water taken from an external heat source comprises a heat exchanger. The heat exchanger comprised in the mentioned aefficient heating management system is suitable for the cooling liquid capacity of the generator. In other words, the exchanger is suitable for the heat transfer area and capacity that can take in the water that needs to circulate inside the generator and meet the heating power and time. The exchanger has a primary input, a primary output, a secondary input, and a secondary output circuit. The water pipeline that carries hot water from the external heat source mentioned above is connected to a primary input circuit of the exchanger. On the primary input, there is a heat sensor and a pressure sensor that measure the temperature of the incoming water from the external heat source.

There is a circulating pump on the hot water pipeline carrying hot water from the heat source connected to the primary input of the heat exchanger. Hot water from the heat source is transported to the integrated system subject to the invention through pipes from the output of the circulation pump. If the output pressure of the external heat source is sufficient, the pump is not needed. This pressure sufficiency is monitored by the pressure sensor located at the heat exchanger inlet, as mentioned above. If the data read by the pressure sensor is below the pressure level defined by the user in the control unit of the generator mentioned above, the circulation pump on the external heat source is activated, and the speed of circulation pumps is increased if they are already activated. If the data read by the sensor is above the defined pressure level, the circulation pump on the external heat source is not activated, since there is no need for it. In one embodiment of the invention, there is a flow rate sensor on the primary circuit for measuring the flow rate of the water coming from the external heat source, which measures the flow rate of the water coming from the external heat source. If the data read by the flow sensor is below the flow rate defined by the user in the control unit of the generator mentioned above, the circulation pump is activated to increase the flow rate, and an electronic controlled valve is intervened. If it is still insufficient, the pot tank is activated, and when the flow rate returns to normal, the pot tank is disabled. All of these activation and deactivation operations are performed through the processor in the generator control unit or the processor in the heating efficiency system.

The system of the invention aims to efficiently and economically bring the diesel engine temperature in the generator to the desired level with less electrical energy consumption, as described in detail above. At this point, stopping the system once it has achieved its intended purpose is also possible. For this process, the temperature sensor on the generator is used. When the processor in the generator control unit or the processor in the heating efficiency system obtains information from the temperature sensor indicating that the generator has reached the desired temperature level, the circulation pumps on the external heat source side and the generator side are stopped. This stopping process is performed by closing the relays connected to the pumps via the processor. In this way, hot water is not transported to the system under the invention, and the water circulation in the diesel engine block is stopped.

The temperature of the generator engine block is monitored and if it falls below a predetermined lower limit value due to any malfunction or possible interruption, a relevant warning is generated and the user is informed through visual and audible signals via the generator control unit or the processor-containing heating efficiency system screen. To enable audible warning, a speaker may be comprised in the generator. The generator control unit or the processor-containing heating efficiency system may be designed to be suitable for remote communication and may comprise wired and wireless communication protocols. Wireless communication protocols may further comprise, but are not limited to, wifi, bluetooth, RFID, NFC. Wired communication protocols may further comprise, but are not limited to, RS 232, RS 485, modbus, canbus meter-bus modules. Users may view and modify the necessary status information and adjustment parameters via the screen of the generator control unit or the processor-containing heating efficiency system, as well as perform the above interventions and controls via scada systems or PC communication.

The temperature reading from the temperature sensor in the generator motor is used to determine when the motor temperature has reached the lower limit, and a command is sent to the external heat source pump (in cases where a pump is used) via the processor in the generator control unit or the heating efficiency system containing the processor. When the pump is activated, the pressure, flow rate, and temperature sensor at the primary inlet of the heat exchanger are used to read the data of the incoming hot water. If the temperature of the incoming water, as read by the temperature sensor, is below the temperature value defined by the user in the software on the processor in the heating efficiency system or the generator control unit using the aforementioned screen, the generator circulation pump is not activated. Thus, the water in the generator motor block is not circulated and does not participate in heat transfer with the hot water from the external heat source. If the temperature of the incoming water from the external heat source, as read by the temperature sensor, exceeds the temperature value defined by the user in the software on the processor in the heating efficiency system or the generator control unit using the aforementioned screen, the processor activates the generator circulation pump, and the water in the generator motor block begins to circulate through the heat exchanger for heat transfer. This ensures that the liquid in the diesel motor block, which is to be heated by the liquid in the external source circuit at the desired temperature, is heated through heat transfer.

The above-described system explains that if the temperature reading from the heat sensor for incoming water is below the temperature value defined by the user through the screen mentioned above, the generator circulation pump does not operate. At this point, a waiting time can be adjusted by the user depending on the distance of the external heat source from the system of the invention. The adjustment process is made through the screen in the heater efficiency system that includes the generator control unit or processor. During this waiting time, it is again monitored by the heat sensor whether the water has reached the desired temperature or not. If the water does not reach the desired temperature value at the end of the waiting time, the system in question is switched to the old system mentioned (if available) in the background section by disabling the generator circulation pump via the processor. This process is applied as a kind of bypass process. The aim here is to heat the generator with old-fashioned systems as a last option if there is an available power supply and to prevent any inconvenience. This purpose is achieved with a three-way valve. As a result of disabling the generator circulation pump, the generator continues to cycle in the old system from the remaining two ways.

The system subject to invention comprises a freezing prevention mode within the software of the processor comprised in the generator control unit or heating efficiency system that further comprises a processor. As mentioned above, it was stated that the incoming water temperature is measured from an external water source and if this water temperature is not at the desired level, it is deactivated. However, circulating water is important for areas with very cold climates. Otherwise, the water freezes in the pipes and can cause explosions, or the systems cannot be put into operation due to freezing. To prevent this, the freezing prevention mode has been designed within the software of the processor comprised in the generator control unit or heating efficiency system that allows water to circulate continuously inside the pipes regardless of the temperature of the circulating water. When this mode is activated, the external heat source circulation pump is activated when the temperature of the liquid coming from the heat exchanger approaches the freezing temperature (can be adjusted via the processor), and the water is continuously circulated. Thus, the water freezing is prevented. This mode can be started or stopped by the user through the screen or wireless communication system.

The secondary circuit of the heat exchanger takes and returns jacket water (the circulating water within the generator) from the generator motor block. This allows heat transfer with the primary circuit, which circulates the water coming from the external heat source. However, the waters circulating inside the heat exchanger never mix with each other. There is no connection between them.

The present invention involves an integrated system for a generator, in which the direct connection between the radiator and the heating pot tank (also known as the block water heater) containing a resistor, used in the prior art, is cut off and the secondary circuit outlet of the exchanger is connected to the inlet of the heating pot tank. In other words, in the present invention, the exchanger is connected between the return of the radiator and the inlet of the heating pot tank, which is the standard connection in conventional systems. If there is a circulation pump in the heating pot tank circuit of the original structure of the generator, the pump is canceled from the existing circuit and transferred to the system of the present invention. If there is no circulation pump in the heating pot tank circuit of the original structure of the generator, a circulation pump can be added to the inlet of the secondary circuit of the exchanger according to the flow and pressure requirements, or it can be used without a pump by leaving it to natural pressure and flow. Power supply is also provided within the system when the pump is used. In short, the circulation pump that will provide the water circulation within the generator is used by utilizing the existing pump in the heating pot tank system, or it is added to the system or not, depending on the situation. The general operating principle of the system is summarized below:
Temperature information is read from the temperature sensor connected to the generator,
The system starts to operate according to the defined lower temperature level for the generator,
When the generator temperature reaches the lower level, the primary circulation of the exchanger is started with the circulation pump at the output of the external heat source (if there is pressure, hot water will be ready at the primary input),
Depending on the distance of the incoming water line, it is waited for a certain period of time,
At the end of the waiting period, if a temperature above the lower level of the generator defined above is detected by the temperature sensor at the primary input of the exchanger, the circulation pump in the secondary circuit is started, and the heat transfer between the two liquid is initiated through the exchangers,
If the primary input temperature does not reach above the lower limit of the generator at the end of the waiting period, the circulation pump of the primary circuit is stopped, it is understood that there is not enough hot water coming from the external heat source, and a warning is given to the user via the screen.
The heating pot and the resistors in the pot are activated. The circulation pump in the secondary circuit is started. The generator water is heated by the resistor as in the old system, and it continues until the upper limit is reached. When the upper limit is reached, the resistor is turned off, the circulation pump in the secondary circuit is stopped, and the generator starts to cool naturally. When the temperature level in the motor block returns to the lower limit, the scenario is restarted with the priority on efficiency and economy for the exchanger system.
When the generator temperature reaches the upper level, both circulation pumps are stopped, and the heat transfer is terminated.
The generator starts to cool naturally, and when the temperature level returns to the lower limit, the cycle is restarted.

In one embodiment of the invention, there is a module that is referred to as a reporting module. This module is located within the generator control unit or the processor of the heating efficiency system. The software comprised in the processor measures both the amount of heat taken/consumed from an external heat source and the amount of heat generated using electricity when the heat source is disabled. This is achieved using a calorimeter and an electric meter. The module can determine the cost of heating by using current electricity and heating unit prices, as well as the duration and quantity of electricity/heat used. These measurements can be transferred to a desired digital platform through the wireless connection module. In this configuration, an electric valve (0-1) is placed at the inlet where water from an external heat source enters. This prevents the calorimeter from being misdirected when the system is in standby mode, i.e., when generator water does not need to be heated. Thus, the calculation of the heat consumed by the system is only made when heating is required.

What is claimed is:

1. An efficient heating management system integrated into a diesel engine generator that enables heating of engine block water using heat obtained from an external heat source, comprising a circulation pump, a heat sensor that measures a temperature of water coming from the external heat source, water transfer pipes, a two-part heat exchanger where the waters do not mix but heat transfer is allowed to be performed, a pressure gauge, a flow sensor, a heating efficiency system control unit further or an internal control device of the generator comprising a screen with an interface and a processor configured for the efficient heating management system, a heat sensor on generator, a generator circulation pump, a three-way motorized and/or non-motorized valve and a reporting module.

2. The efficient heating management system according to claim 1, comprising a primary inlet, a primary outlet, a secondary inlet and a secondary outlet circuit of the two-part heat exchanger.

3. The efficient heating management system according to claim 2, wherein the circulation pump is located on a pipeline connected to the primary inlet of the two-part heat exchanger.

4. The efficient heating management system according to claim 3, wherein the circulation pump located on a primary inlet line of the two-part heat exchanger comprises a relay that provides communication between the circulation pump and the processor.

5. The efficient heating management system according to claim 1, comprising the processor with a software that activates the circulation pump on an external heat source side when data read by a pressure sensor falls below a pressure value defined by a user in the software via the screen, and increasing a speed of already activated circulation pumps.

6. The efficient heating management system according to claim 1, comprising the processor with a software that activates the circulation pump on the external heat source when data obtained from the flow sensor is below a flow rate defined by a user in the software in the processor via the screen.

7. The efficient heating management system according to claim 1, comprising the processor that stops the circulation pumps by closing relays of the circulation pump on an external heat source side and the circulation pump on a generator side when a desired temperature level of the generator is reached, as detected by a temperature sensor on the generator.

8. The efficient heating management system according to claim 1, comprising a three-way valve on a generator side before the two-part heat exchanger that enables the system to be deactivated by the processor or by a command given by a user through the interface on the screen.

9. The efficient heating management system according to claim 1, comprising a speaker allowed for generating an audible warning to a user when a temperature of a generator motor block falls below a set lower limit value due to any malfunction or in case of a possible interruption.

10. The efficient heating management system according to claim 1, comprising the heating efficiency system control unit further or the internal control device of the generator further comprising wired and wireless communication protocols.

11. The efficient heating management system according to claim 1, comprising the processor determines whether a motor temperature has reached a lower limit according to a temperature reading from a temperature sensor in the generator and sends a command to an external heat source pump.

12. The efficient heating management system according to claim 1, comprising the processor that enables the circulation pump on a generator side to be activated and starts a circulation of a coolant in a generator motor block through the exchanger for heat transfer when the temperature of the water from the external heat source detected by a temperature sensor is above a temperature set by a user via the screen to a software comprised in the processor.

13. The efficient heating management system according to claim 12, comprising the processor that tracks whether the water has reached a desired temperature through the temperature sensor during waiting time set by the user, and when the water does not reach a desired temperature value at an end of a waiting period, disables the system.

14. The efficient heating management system according to claim 1, comprising the processor further comprising a software with a freezing prevention mode that constantly circulates the water by activating a external heat source circulation pump regardless of a circulating water temperature.

15. The efficient heating management system according to claim 1, comprising a calorimeter and an electric meter that allow both measurement of an amount of heat taken/consumed from the external heat source and measurement of-the heat produced by electric heating when the external heat source is disabled, with the reporting module comprised in a software comprised by the processor in a generator control unit or in a heating efficiency system.

16. The efficient heating management system according to claim 15, by-comprising a 0-1 electric valve at an inlet where the water coming from the external heat source is located.
